(19) United States
(12) Patent Application Publication
(10) Pub. No.: US 2008/0315164 A1
(43) Pub. Date: Dec. 25, 2008

(54) Flame-retardant prepreg

(75) Inventor: Chih-Feng Wei, Kaohsiung City (TW)

Correspondence Address: Paul D. Greeley;Ohlandt, Greeley, Ruggiero & Perle, L.L.P., 10th Floor, One Landmark Square, Stamford, CT, 06901-2682, US

(73) Assignee: ADVANCED INTERNATIONAL MULTITECH CO., LTD.

(21) Appl. No.: 11/999,630

(22) Filed: Dec. 6, 2007

(30) Foreign Application Priority Data
Jun. 22, 2007 (TW) 096122486

(51) Int. Cl. C09K 21/00

(52) U.S. Cl. 252/601

(57) ABSTRACT

A flame-retardant prepreg includes: a fibrous reinforcing material; and a flame-retardant composition having an epoxy equivalent weight ranging from 190-270g/eq, and including an epoxy resin, a flame-retardant inorganic agent, a thermoplastic resin, and a curing agent. The flame-retardant inorganic agent is in an amount ranging from 12 to 18 parts by weight per 100 parts by weight of the flame-retardant composition.

### CROSS-REFERENCE TO RELATED APPLICATION

This application claims priority of Taiwanese application no. 096122486, filed on Jun. 22, 2007.

### BACKGROUND OF THE INVENTION

1. Field of the Invention

This invention relates to a flame-retardant prepreg, more particularly to a flame-retardant prepreg including a flame-retardant composition having a flame-retardant inorganic agent.

2. Description of the Related Art

Fiber reinforced composites have been used in various fields including sports and transportation.

A conventional fiber reinforced composite includes a plurality of prepregs, each of which includes a fibrous reinforcing material and a resin composition that has a thermoplastic resin dissolved in a thermosetting resin for enhancing tackiness, drapability and windability of the prepreg. The thermosetting resin used is mainly epoxy resin due to its excellent mechanical and chemical properties. Since the aforesaid conventional fiber reinforced composite is not flame retardant, the same is normally coated with a flame-retardant material on a surface thereof. However, the flame retardation of the fiber reinforced composite thus formed is still inefficient.

### SUMMARY OF THE INVENTION

Therefore, the object of the present invention is to provide a flame-retardant prepreg that can overcome the aforesaid drawback associated with the prior art.

According to the present invention, a flame-retardant prepreg comprises: a fibrous reinforcing material; and a flame-retardant composition having an epoxy equivalent weight ranging from 190-270 g/eq, and including an epoxy resin, a flame-retardant inorganic agent, a thermoplastic resin, and a curing agent. The flame-retardant inorganic agent is in an amount ranging from 12 to 18 parts by weight per 100 parts by weight of the flame-retardant composition.

### DETAILED DESCRIPTION OF THE PREFERRED EMBODIMENT

The preferred embodiment of a flame-retardant prepreg according to this invention is illustrated as follows.

The flame-retardant prepreg includes: a fibrous reinforcing material; and a flame-retardant composition having an epoxy equivalent weight ranging from 190-270 g/eq, and including an epoxy resin, a flame-retardant inorganic agent, a thermoplastic resin, and a curing agent. The flame-retardant inorganic agent is in an amount ranging from 12 to 18 parts by weight per 100 parts by weight of the flame-retardant composition.

Preferably, the flame-retardant composition and the fibrous reinforcing material are respectively in an amount ranging from 35 to 50 parts and from 50 to 65 parts by weight per 100 parts by weight of the flame-retardant prepreg, and more preferably are respectively in an amount ranging from 35 to 40 parts and from 60 to 65 parts by weight per 100 parts by weight of the flame-retardant prepreg.

Preferably, the flame-retardant composition has an epoxy equivalent weight ranging from 200 to 230 g/eq.

The epoxy equivalent weight is the molecular weight of the epoxy resin divided by the equivalent number of the epoxy resin used in the flame-retardant composition. The amounts of the thermoplastic resin and the curing agent used in the flame-retardant composition are related to the epoxy equivalent weight of the flame-retardant composition.

Preferably, the epoxy resin, the flame-retardant inorganic agent, the thermoplastic resin and the curing agent are respectively in an amount ranging from 35-50 parts, from 12-18 parts, from 14-20 parts and from 20-30 parts by weight per 100 parts by weight of the flame-retardant composition.

More preferably, the epoxy resin, the flame-retardant inorganic agent, the thermoplastic resin and the curing agent are respectively in an amount ranging from 40-50 parts, from 14-17 parts, from 15-18 parts and from 20-25 parts by weight per 100 parts by weight of the flame-retardant composition.

Preferably, the flame-retardant prepreg has a glass transition temperature greater than 170° C.

In this embodiment, the amount of the curing agent is calculated according to the formula

curing agent percentage (wt %)=(equivalent weight of the curing agent)/(epoxy equivalent weight of the flame-retardant composition)×R×100%, where R=0.7−1.2.

Preferably, the fibrous reinforcing material is unidirectional and is selected from the group consisting of a reinforcing fiber, a reinforcing textile, and combinations thereof.

Preferably, the reinforcing textile is selected from one of cloth, non-woven cloth, webbing band, and webbing cloth.

Preferably, the reinforcing fiber is selected from the group consisting of carbon fiber, basalt fiber, glass fiber, polyamide fiber, and combinations thereof. In this embodiment, the reinforcing fiber is carbon fiber.

Preferably, the epoxy resin is selected from the group consisting of bisphenol A type epoxy resin, bisphenol F type epoxy resin, novolac resin type epoxy resin, and combinations thereof.

Preferred examples of bisphenol A type epoxy resin include Epikote 1001, Epikote 828 (produced by Hexion Resolution Co.), and DER 661 (produced by Dow Chemical Co.).

Preferred examples of bisphenol F type epoxy resin include Epikote 862 (produced by Hexion Resolution Co.), and DER 354 (produced by Dow chemical Co. ).

Preferred examples of novolac resin type epoxy resin include Epikote 154 (produced by Hexion Resolution Co.), and DER 438 (produced by Dow chemical Co. ).

Preferably, the flame-retardant inorganic agent is selected from the group consisting of polyphosphate, antimony trioxide (Sb₂O₃), aluminum hydroxide, magnesium oxide, and combinations thereof.

Preferably, the flame-retardant inorganic agent is polyphosphate marketed as S-20 (produced by Kingyorkor Enterprise Co. Ltd.), FR CROS® S10 or FR CROS® 484 (produced by Budenheim Co.). In this embodiment, the flame-retardant inorganic agent is made from ammonium polyphosphate.

Preferably, the thermoplastic resin is selected from the group consisting of phenoxy resin, polyhydroxyether resin, modified epoxy resin with toughness elastomers, and combinations thereof.

Preferably, the phenoxy resin is PKHH (produced by InChem Co.), and the modified epoxy resin with toughness elastomers is Epolec® (produced by Epotech Composite Co.).

In this embodiment, the curing agent is made from 4,4′-sulfonyldianiline (DDS) (produced by Hiperchem Co. ).

A method for making the flame-retardant composition of this invention includes: (a) adding a mixture of an epoxy resin, a flame-retardant inorganic agent, a thermoplastic resin, and an additive (optional) into a container; (b) stirring the mixture under a temperature ranging from 130° C. to 170° C. so as to obtain a molten-form solution; and (c) adding a curing agent into the solution with stirring so as to form the flame-retardant composition.

Preparation of the prepreg of this invention can be conducted in a conventional manner, such as wet method, hot-melt method or hot-melt coating method. In this embodiment, preparation of the prepreg is conducted using the hot-melt coating techniques.

The method for making the prepreg includes: (a) coating the flame-retardant composition on a release paper such that the coating has a weight per unit area ranging from 30 to 100 g/cm² and that the coating operation is conducted under a coating temperature ranging from 75° C. to 85° C.; and (b) stacking the coated paper and a fibrous reinforcing material on a prepreg-forming machine under a setting condition so as to form the prepreg.

### Testing Method

Glass transition temperature (T_{g}) of the prepreg thus formed was tested using a Differential Scanning Calorimetry (DSC) Instrument.

Tackiness was tested using a roller.

Folding treatment: the prepreg was cut into a 10 cm×10 cm specimen, which was then folded diagonally. If the specimen unfolds within 10 sec, it is classified as ‘too hard’, if within 10-30 sec, it is classified as ‘slightly hard’, and if over 30 sec, it is classified as ‘ok’.

Measurements in the tensile strength, tensile modulus, shear strength, 90° flexural strength, 90 ° flexural modulus, 0° flexural strength, and 0 ° flexural modulus were based on the standards of ASTM D3039, D3518, and D790 tests, respectively.

Flammability test was based on the standard of UL94 test. The term “V0” is a strictest test and the term “V2” is a least strict test.

The merits of the flame-retardant prepreg of this invention will become apparent with reference to the following Examples and Comparative Example.

### EXAMPLE

### Chemicals used for Examples 1-5 (E1-5) and Comparative Example 1 (CE1)

(1) epoxy resin: bisphenol A type epoxy resin (Epikote 1001, Epikote 828), bisphenol F type epoxy resin (Epikote 862), novolac resin type epoxy resin (Epikote 154)

(2) inorganic flame-retardant agent: ammonium polyphosphate (S-20).

(3) thermoplastic resin: PKHH and Epolec®

(4) curing agent: DDS

(5) fibrous reinforcing material: Carbon fiber.

### Making a Flame-Retardant Composition

The flame-retardant composition of Examples 1-5 and Comparative Example 1 were prepared by the same following steps, except that the components used and/or the amounts of the components used in the flame-retardant composition were different.

The components of the flame-retardant composition were mixed and stirred under a temperature of 150° C. for more than 4 hours until the mixture was melted. After cooling the molten mixture to a temperature of 100° C., a curing agent was added into the mixture, and the mixture was constantly stirred and was slowly cooled to a temperature of 80° C. to form the flame-retardant composition.

Table 1 shows the content of each of the components of the flame-retardant composition of Examples 1-5 and Comparative Example 1.

TABLE 1

| Material/content (wt %) | | E1 | E2 | E3 | E4 | E5 | CE1 |
|---|---|---|---|---|---|---|---|
| Epoxy resin | Epikote 1001 | 0 | 2.0 | 5.9 | 23.5 | 5.9 | 20.3 |
| | Epikote 828 | 28.6 | 20.0 | 27.8 | 20.1 | 27.8 | 20.0 |
| | Epikote 154 | 1.1 | 18.9 | 7.9 | 5.3 | 7.9 | 5.2 |
| | Epikote 862 | 5.3 | 4.0 | 4.0 | 1.1 | 4.0 | 9.0 |
| | Total amount | 35.0 | 44.9 | 45.6 | 50.0 | 45.6 | 54.5 |
| | (wt %) | | | | | | |
| Thermoplastic | PKHH | 1.1 | 3.8 | 7.9 | 4.9 | 7.9 | 12.0 |
| resin | Epolec ® | 18.9 | 11.9 | 9.9 | 9.1 | 9.9 | 3.5 |
| | Total amount | 20.0 | 15.7 | 17.8 | 14.0 | 17.8 | 15.5 |
| | (wt %) | | | | | | |
| Flame-retardant | S-20 | 18.0 | 15.2 | 15.9 | 12.0 | 15.9 | 11.3 |
| agent | | | | | | | |
| Curing agent | DDS | 27.0 | 24.2 | 20.7 | 24.0 | 20.7 | 18.7 |

### Making a Flame-Retardant Prepreg

### Examples 1-5 and Comparative Example 1

The flame-retardant composition thus formed was disposed in a resin container of a hot-melt coater, and was then coated on a release paper on the hot-melt coater under a coating temperature of 80° C. The coated release paper was stacked with the fibrous reinforcing material on a prepreg machine for thermal pressing to form into a laminate. The thermal pressing operation was conducted under a hot pressing roller temperature ranging from 110 to 130° C. for each of three pairs of the hot pressing rollers, a hot pressing plate temperature ranging from 90 to 100° C., a cooling plate temperature of less than 15° C., a pressing roller pressure ranging from 5 to 15 kg/cm² for each of the three pairs of the hot pressing rollers, a feed speed ranging from 4 to 12 m/min, and a nip gap between each pair of the rollers ranging from 0.16 to 0.48 mm. The weight per unit area of the fibrous reinforcing material of the prepreg thus formed was about 150 g/cm² for Examples 1-4 and Comparative Example 1, and was about 200 g/cm² for Example 5. The weight per unit area of the prepreg thus formed was about 238 g/cm² for Examples 1-4 and Comparative Example 1, and was about 400 g/cm² for Example 5. The ratio of weight per unit area of the flame-retardant composition to that of the prepreg thus formed was 37 wt % for Examples 1-4 and Comparative Example 1, and was about 50 wt % for Example 5.

Note that the fibrous reinforcing material employed for Examples 1-4 and Comparative Example 1 was made from carbon fiber marketed as Toho Tenax HTS-12K (produced by Toray Co.), which has a tensile strength of 4300 MPa, a tensile modulus of 238 GPa, an elongation of 2.1% and a density of 1.8 g/cm³. The fibrous reinforcing material employed for Example 5 was made from carbon fiber marketed as T300-3K (produced by Toray Co.), which has a tensile strength of 3530 MPa, a tensile modulus of 230 GPa, an elongation of 1.5% and a density of 1.76 g/cm³.

Table 2 shows the test results of the prepregs of Examples 1-5 and Comparative Example 1.

TABLE 2

| | | E1 | E2 | E3 | E4 | E5 | CE1 |
|---|---|---|---|---|---|---|---|
| Flame-retardant | Epoxy | 194 | 204 | 227 | 269 | 227 | 273 |
| Composition | Equivalent | | | | | | |
| | weight | | | | | | |
| | (g/eq) | | | | | | |
| | Tg (° C.) | 200.6 | 183.1 | 173.7 | 175.0 | 173.7 | 164.0 |
| prepreg | Tackiness | ok | Slightly | ok | Slightly | ok | not |
| | | | tacky | | dry | | tacky |
| | Folding | ok | Ok | ok | Slightly | ok | Too hard |
| | treatment | | | | hard | | |
| | Tensile | 1481 | 1828 | 2225 | 1465 | 1678 | — |
| | strength (MPa) | | | | | | |
| | Tensile | 110 | 128 | 138 | 110 | 1025 | — |
| | modulus (GPa) | | | | | | |
| | Shear | 5.5 | 6.6 | 5.9 | 6.2 | — | — |
| | strength (MPa) | | | | | | |
| | 90° Flexural | 32.1 | 78 | 62 | 31.7 | — | — |
| | strength (MPa) | | | | | | |
| | 90° Flexural | 3.9 | 8.1 | 8.7 | 3.8 | — | — |
| | modulus (GPa) | | | | | | |
| | 0° Flexural | 1133 | 1280 | 1561 | 1058 | — | — |
| | strength (MPa) | | | | | | |
| | 0° Flexural | 104 | 114 | 144 | 97 | — | — |
| | modulus (GPa) | | | | | | |
| | Flammability | V0 | V0 | V0 | V0 | V0 | X |

where [—] means no test

The results show that Comparative Example 1 failed the flammability test, and that Examples 1-5 not only exhibited excellent flame retardation but also maintained the desired mechanical properties for application to articles, such as vehicle interiors, ceilings, partition walls, etc.

It has thus been shown that, by adding the flame-retardant inorganic agent in an amount ranging from 12 to 18 parts by weight per 100 parts by weight of the flame-retardant composition, the aforesaid drawback associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. A flame-retardant prepreg comprising:
a fibrous reinforcing material; and
a flame-retardant composition having an epoxy equivalent weight ranging from 190-270 g/eq, and including
an epoxy resin,
a flame-retardant inorganic agent,
a thermoplastic resin, and
a curing agent;
wherein said flame-retardant inorganic agent is in an amount ranging from 12 to 18 parts by weight per 100 parts by weight of said flame-retardant composition.

2. The flame-retardant prepreg of claim 1, wherein said flame-retardant composition and said fibrous reinforcing material are respectively in an amount ranging from 35 to 50 parts and from 50 to 65 parts by weight per 100 parts by weight of said flame-retardant prepreg.

3. The flame-retardant prepreg of claim 2, wherein said flame-retardant composition and said fibrous reinforcing material are respectively in an amount ranging from 35 to 40 parts and from 60 to 65 parts by weight per 100 parts by weight of said flame-retardant prepreg.

4. The flame-retardant prepreg of claim 1, wherein said flame-retardant composition has an epoxy equivalent weight ranging from 200 to 230 g/eq.

5. The flame-retardant prepreg of claim 4, wherein said epoxy resin, said flame-retardant inorganic agent, said thermoplastic resin and said curing agent are respectively in an amount ranging from 35-50 parts, from 12-18 parts, from 14-20 parts and from 20-30 parts by weight per 100 parts by weight of said flame-retardant composition.

6. The flame-retardant prepreg of claim 5, wherein said epoxy resin, said flame-retardant inorganic agent, said thermoplastic resin and said curing agent are respectively in an amount ranging from 40-50 parts, from 14-17 parts, from 15-18 parts and from 20-25 parts by weight per 100 parts by weight of said flame-retardant composition.

7. The flame-retardant prepreg of claim 1, wherein said flame-retardant prepreg has a glass transition temperature greater than 170° C.

8. The flame-retardant prepreg of claim 5, wherein the amount of said curing agent is calculated according to the formula
curing agent percentage (wt %)=(equivalent weight of said curing agent)/(epoxy equivalent weight of said flame-retardant composition)×R×100% wherein R=0.7−1.2.

9. The flame-retardant prepreg of claim 1, wherein said fibrous reinforcing material is selected from the group consisting of a reinforcing fiber, a reinforcing textile, and combinations thereof.

10. The flame-retardant prepreg of claim 9, wherein said reinforcing fiber is selected from the group consisting of carbon fiber, basalt fiber, glass fiber, polyamide fiber, and combinations thereof.

11. The flame-retardant prepreg of claim 1, wherein said epoxy resin is selected from the group consisting of bisphenol A type epoxy resin, bisphenol F type epoxy resin, novolac resin type epoxy resin, and combinations thereof.

12. The flame-retardant prepreg of claim 1, wherein said flame-retardant inorganic agent is selected from the group consisting of polyphosphate, antimony trioxide (Sb₂O₃), aluminum hydroxide, magnesium oxide, and combinations thereof.

13. The flame-retardant prepreg of claim 12, wherein said flame-retardant inorganic agent is made from ammonium polyphosphate.

14. The flame-retardant prepreg of claim 1, wherein said thermoplastic resin is selected from the group consisting of phenoxy resin, polyhydroxyether resin, modified epoxy resin with toughness elastomers, and combinations thereof.

15. The flame-retardant prepreg of claim 1, wherein said curing agent is made from 4,4′-sulfonyldianiline.
